(19) United States
(12) Patent Application Publication
(10) Pub. No.: US 2016/0004701 A1
(43) Pub. Date: Jan. 7, 2016

(54) Method for Representing Document as Matrix

(71) Applicant: University of Seoul Industry Cooperation Foundation, Seoul (KR)

(72) Inventor: Han Joon KIM, Seoul (KR)

(21) Appl. No.: 14/749,885

(22) Filed: Jun. 25, 2015

(30) Foreign Application Priority Data
Jun. 25, 2014 (KR) 10-2014-0078416

(51) Int. Cl. G06F 17/30

(52) U.S. Cl. CPC G06F 17/3053; G06F 17/30867

(57) ABSTRACT

A method for representing a document as a matrix in an electronic device comprising a processor and a memory storing instructions executed by the processor and the method includes creating a term vector comprising at least one term in the document, calculating a weight of each of the at least one term for each of at least one concept in the document and representing the document as a matrix by mapping the at least one term included in the document onto any one of rows and columns of the matrix, and mapping the at least one concept onto the other of the rows and columns of the matrix and the matrix comprises a weight the at least one term has in the document as a component.

### RELATED APPLICATIONS

This application is based on and claims priority to Korean Patent Application No. 10-2014-0078416, filed on Jun. 25, 2014, the disclosure of which is incorporated herein in its entirety by reference.

(This work was supported by Mid-career Researcher Program through the National Research Foundation of Korea (NRF) grant funded by the Korea government (MISP) (No: NRF-2013R1A2A2A010170 30)

(Korean Government-funded Project Title: Research about Big Text Mining Framework based on Semantic Text Cuboid Model)

### FIELD OF THE INVENTION

The present invention relates to a method for representing a document as a matrix, and more particularly to a method for representing terms the document includes and concepts that the corresponding term has in the document as a matrix.

### BACKGROUND OF THE INVENTION

The Digital Universe Study published by IDC (International Data Corporation), a market research analysis and advisory firm, reveals the estimated volume of data created in 2011 is about 1.8 zettabytes, and the volume would be more than 50 times in the next 10 years. The lookout is that unstructured or semi-structured data would account for about 90% of the data. In this context, it is predicted that most significant information would exist as unstructured/semi-structured data.

Text mining refers to the process of extracting and processing high-quality information from big unstructured/semi-structured documents including the aforementioned unstructured or semi-structured data.

Text mining involves diverse technologies such as automatic document classification, document clustering, association analysis, intelligent information retrieval, information recommendation, conceptual network, and the like. Execution of the aforementioned specific technologies of text mining is based on representation types of unstructured/semi-structured documents. Therefore, a method of representing unstructured/semi-structured documents can affect the performance of the particular technologies of text mining.

The method of representing documents should be able to represent what terms a document includes and what concept (meaning) the terms have in the document. Specifically with respect to this, because a document is a set of terms, it should be able to be represented by using at least one term. In addition, because each of terms included in the document may have various concepts (meanings) depending on context, its concepts should be able to be represented along with the terms for representing the document.

However, a conventional method of representing a document does not represent what concept (meaning) a particular term has. For example, although the Bag-of-Words model represents a document as terms, it does not represent what concept (meaning) a particular term has, but just represents the significance of the term based on its frequency within the document. Another exemplary method of mapping terms included in a document or the subset of terms onto concepts to represent a document does not represent a document as terms, but as concepts. Therefore, the method represents concepts hidden in a document, but is not capable of representing the concepts of each term included in the document.

Therefore, there has been a need of an effective method to represent what terms a document includes while representing what concept each term has in the document, in the method for representing a document.

### SUMMARY OF THE INVENTION

The present invention aims to address all problems aforementioned.

In accordance with the present invention, there is provided a method for representing a document as a matrix in an electronic device comprising a processor and a memory storing instructions executed by the processor and the method includes creating a term vector comprising at least one term in the document, calculating a weight of each of the at least one term for each of at least one concept occurring in the document and representing the document as a matrix by mapping the at least one term included in the document onto any one of rows and columns of the matrix, and mapping the at least one concept with the other of the rows and columns of the matrix and the matrix comprises the weight that at least one term has in the document as a component.

Further, the method includes creating a concept space comprising the at least one concept.

Further, the concept space is created by using an ontology.

Further, the concept is allocated a webpage constructing an online encyclopedia.

Further, whether to allocate the webpage to the concept is determined on the basis of at least one of the volume of pages of the webpage, the number of backlinks, or special entities included in the title of the webpage.

Further, the concept comprises at least one keyword calculated by applying tf*idf (Term Frequency*Inverse Document Frequency) to the term contained in the webpage allocated to the concept.

Further, the method includes creating a concept vector comprising the weight, and the concept vector is created for each of the at least one term.

Further, the weight indicates quantitative closeness to each of the at least one concept of each of the at least one term.

Further, said creating the concept vector for a first term among the at least one term includes establishing the first term as a center term, establishing terms within a radius predefined in the term vector as neighboring terms based on the first term, determining whether the first term and each of the neighboring terms are included in each of the at least one concept and calculating a weight of the first term for each of the at least one concept on the basis of the result from the determination.

Further, each of the at least one concept comprises at least one keyword showing a corresponding concept.

Further, said determining whether the first term and each of the neighboring terms are included in each of the at least one concept is based on determination of whether the first term and each of the neighboring terms match at least one keyword.

Further, said calculating a weight of the first term for each of the at least one concept includes allocating ‘1’ to the concept of the corresponding term if the first term and each of the neighboring terms are comprised in the concept and otherwise ‘0’ and calculating the sum of the allocated numbers for each of the at least one concept as a weight of the first term for the concept.

Further, in said calculating the weight of the first term for each of the at least one concept includes calculating as the weight the value obtained by dividing the sum by the first term and the number of neighboring terms.

In accordance with the present invention, the method for representing a document may represent what terms a document includes and what concept the terms have in the document.

### BRIEF DESCRIPTION OF THE DRAWINGS

FIG. 1 shows a document represented as a matrix in accordance with an embodiment of the present invention;

FIG. 2A shows a document corpus represented by using a third-order tensor of term-document-concept composed of a term space, a concept space and a document space (a cuboid model) in accordance with an embodiment of the present invention;

FIG. 2B shows the relationship between the term space, the concept space and the document space in accordance with an embodiment of the present invention;

FIG. 2C shows a cuboid model in accordance with an embodiment of the present invention;

FIG. 3 shows a concept vector created in accordance with an embodiment of the present invention;

FIG. 4 shows an exemplary process of creating the concept vector in accordance with an embodiment of the present invention;

FIG. 5 shows a method of representing a document corpus as a third-order tensor of term-document-concept in accordance with an embodiment of the present invention; and

FIG. 6 shows a method for creating a concept vector in accordance with an embodiment of the present invention.

### DETAILED DESCRIPTION OF THE EMBODIMENTS

The advantages and features of exemplary embodiments of the present invention and methods of accomplishing them will be clearly understood from the following description of the embodiments taken in conjunction with the accompanying drawings. However, the present invention is not limited to those embodiments and may be implemented in various forms. It should be noted that the embodiments are provided to make a full invention and also to allow those skilled in the art to know the full scope of the present invention. Therefore, the present invention will be defined only by the scope of the appended claims. Similar reference numerals refer to the same or similar elements throughout the drawings.

In the following description, well-known functions and/or constitutions will not be described in detail if they would unnecessarily obscure the features of the invention in unnecessary detail. Further, the terms to be described below are defined in consideration of their functions in the embodiments of the invention and may vary depending on a user's or operator's intention or practice. Accordingly, the definition may be made on a basis of the content throughout the specification.

Meanwhile, at least some or all of the methods for representing a document as a matrix suggested as an embodiment of the present invention may be implemented in a hybrid implementation of software and hardware on an electronic device comprising at least a processor and a memory for storing instructions to be executed by the processor, or a programmable machine selectively activated or reconfigured by means of computer programs.

In addition, at least some or all of the methods for representing a document as a matrix suggested in an embodiment of the present invention may be implemented in one or more universal network host machines, for example, computers, network servers or server systems, mobile computing devices (for example, PDAs (Personal Digital Assistants), mobile phones, smartphones, laptop computers, tablet computers or their equivalents), consumer electronics, other appropriate electronic devices or combinations thereof.

In addition, at least some or all of the methods for representing a document as a matrix suggested in an embodiment of the present invention may be implemented in one or more virtualized computing environments (for example, network computing clouds or their equivalents).

Hereinafter, the embodiments of the present invention will be described in more detail with reference to accompanying drawings. However, the description of the embodiments of the present invention may be based on the assumption that a matrix has the same meaning as a second-order tensor.

In addition, in the embodiments of the present invention, the ‘term’ may have the same meaning as ‘word’ or ‘expression’, the ‘concept’ as ‘semantic’ or ‘notion’, and the ‘document’ as ‘text’ or ‘text document’.

In addition, a document corpus refers to a plurality of documents.

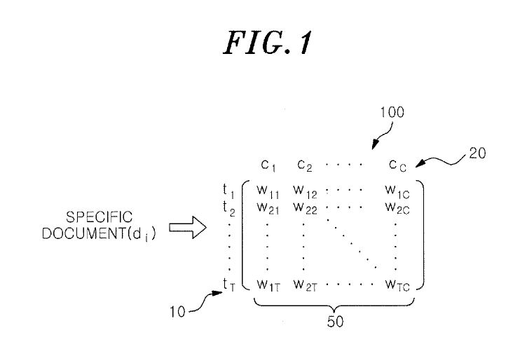

FIG. 1 shows a document represented in a term-concept matrix composed of a term space and a concept space in accordance with an embodiment of the present invention.

Referring to FIG. 1, more specifically in the method for representing a document in accordance with an embodiment of the present invention, a specific document dᵢ may be represented in a term-concept matrix 100 composed of a term space 10 and a concept space 20.

In this case, the term space 10 may be a space for representing at least one term the document dᵢ includes. For example, the at least one term the document dᵢ includes may be represented in the term space 10 composed of terms t₁ to t_{T}. In this case, the specific document dᵢ may be represented as a vector in the term space 10, and such a vector may be referred to as a term vector.

In addition, the concept space 20 may be a space for representing the concept of the at least one term the specific document dᵢ includes. For example, at least one concept of the terms included in the specific document dᵢ may be represented in the concept space 20 composed of concepts c₁ to c_{c}. In this case, the concept of the term included in the specific document dᵢ may be represented as a vector in the concept space 20, and such a vector may be referred to as a concept vector.

In this regard, the term space 10 and the concept space 20 may be equated and distinct vector spaces each other.

The term space 10 and the concept space 20 may form a term-concept matrix 100. For example, as shown in FIG. 1, the term space 10 and the concept space 20 may correspond to rows and columns in the term-concept matrix 100, respectively. However, this is just an example, not limiting an embodiment that the term space 10 corresponds to columns and the concept space 20 to rows.

The aforementioned term-concept matrix 100 may represent terms included in the specific document dᵢ in the term space 10, and the concepts of terms included in the specific document dᵢ in the concept space 20 for each term.

More specifically for the configuration, the term-concept matrix 100 may represent which concept at least one term included in the specific document dᵢ is close to in terms of understanding, that is, represent a closeness of the term to a concept as a weight w₁₁ to w_{TC} 50.

For example, if a term is closer to a concept c₂ than another concept c₁ in a specific document dᵢ, the weight may have a greater value in the concept c₂ than the concept c₁.

As described above, in accordance with an embodiment of the present invention, a document may be represented as a term-concept matrix composed of a term space and a concept space. In this case, the term space and the concept space are equated and distinct vector spaces with each other. The term-concept matrix for a document may be represented on a plane based on the term space and the concept space equated with each other as distinct vector spaces.

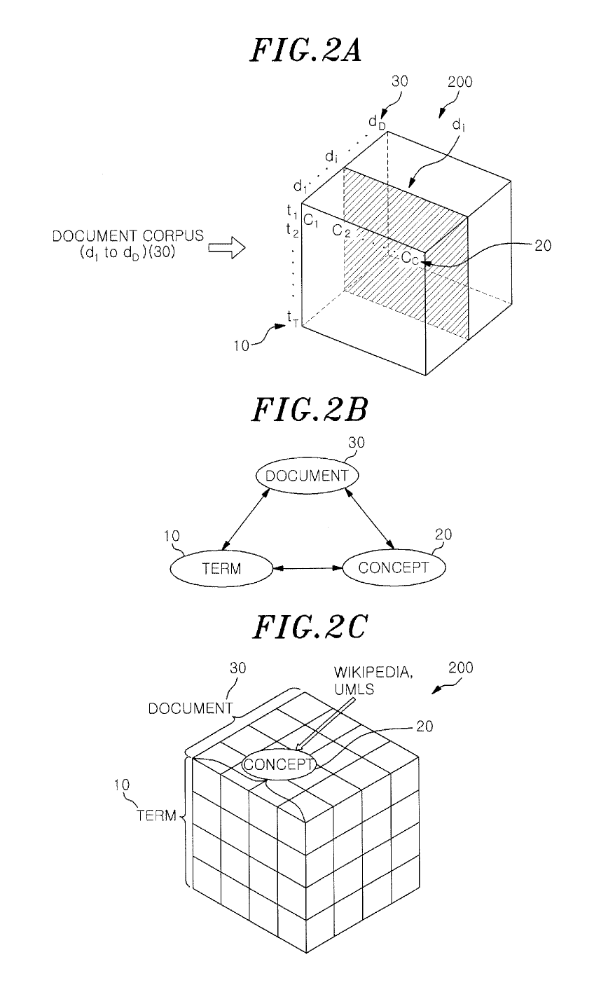

Therefore, referring to FIGS. 2A and 2C, if a document is represented on a plane by using the term-concept matrix, a document corpus represented as such may be represented as a third-order tensor in a space composed of a term space, a document space and a concept space.

Referring to FIGS. 2Aa and 2C, the document corpus d₁ to d_{D} 30 may be represented as a third-order tensor 200 composed of a term space 10, a concept space 20 and a document space 30. A model for using a third-order tensor composed of the term space 10, the concept space 20 and the document space 30 to represent a document corpus 30 is hereinafter referred to as a cuboid model 200.

In the cuboid model 200, the term space 10 may be a space for representing what terms the document included in document space 30 includes. In addition, the concept space 20 may be a space for representing what concept the term included in the document has with respect to the document included in the document space 30.

In addition, the document space 30 may be a space for representing a document corpus represented by means of the cuboid model 200. Therefore, the document space 30 is denoted as the same as the document corpus d₁ to d_{D} 30. However, this is just an example, and the document space 30 may be a different document corpus, not the document corpus d₁ to d_{D} to be represented in the example.

In this case, the term space 10, the concept space 20 and the document space 30 are equated and distinct vector spaces each other. That is, referring to FIG. 2B, the term, the concept and the document are equated and distinct each other in the cuboid model.

In the cuboid model 200, the term may be represented with a space and a document, the space with a document and a concept, and the concept with a term and a document. These characteristics may be applied to particular technologies of text mining. For example, representation of terms by using the concept-document matrix allows an analysis of concept types of corresponding terms in a document corpus.

The above description is about using a term-concept matrix to represent terms of a specific document in the term space, and represent concepts of terms included in the specific document as a weight for each term in the concept space. If the term-concept matrix is extended to a document corpus, the document corpus may be represented as a third-order tensor, that is, cuboid model, composed of a term space, a document space and a concept space.

In this case, it is essential that a specific document may be represented in the term space in order to represent the concepts of the terms included in the specific document in the concept space as a weight for each term. It is also essential that the concept that each term represented in the term space may have in a specific document may be calculated as a weight in the concept space. Therefore, the process illustrated above will be described below in sequence while referring to FIG. 1.

Referring to FIG. 1 again, the specific document dᵢ may be represented as a term vector in the term space 10. In this case, the term included in the term vector may be a term (informative term) including information about the specific document dᵢ, and may be represented with the following Equation 1:

tv(dᵢ)=(t₁,t₂,t₁, . . . ,t_{T}) (1)

where tv(dᵢ) is a term vector for a specific document dᵢ, and terms t₁ to t_{T} are the terms including the information about the specific document dᵢ.

In addition, the distance between terms on the term vector may be proportional to the distance where the terms are positioned in the document. For example, in the Equation 1, the distance from t₁ to t₂ in the document may be closer than the distance from t₁ to t₃. However, this is just an example, not limiting other types of distance.

However, because this is a well-known technology in the art for extracting terms including information from a document and representing them as a vector, particular description about the technology is not provided herein.

Next, the weight wⱼₖ 50 for the concepts of the terms included in the specific document dᵢ may be represented by using the concept vector for each term included in the term vector created for the specific document dᵢ. In this case, the concept vector for each term may be obtained with, for example, Equation 2:

cv(tⱼ,dᵢ)=<w(c₁,tⱼ,dᵢ),w(c₂,tⱼ,dᵢ), . . . ,w(c_{c},tⱼdᵢ)> (2)

where cv(tⱼ,dᵢ) is a concept vector representing the weight for each concept c₁ to c_{c} of a specific term tⱼ in a specific document dᵢ as a vector in the concept space 20, and w(cₖ,tⱼ,dᵢ) is a value representing the weight of a specific concept cₖ of a specific term tⱼ in the specific document dᵢ.

The concept of each term t₁ to t_{T} included in the term vector created for the specific document dᵢ may be represented in the concept space 20. It is essential that the concept space 20 comprehensively include both the specific document dᵢ and the document corpus including the specific document dᵢ. To this end, the concept space 20 in an embodiment of the present invention may be established by using a World Knowledge ontology.

In this case, using an ontology to establish the concept space 20 is just an example, and the present invention does not limit other methods for establishing a concept space. For example, the present invention may include embodiments of establishing a concept space in various manners. The aforementioned exemplary manners may include an embodiment of using specific document corpora (text corpora), thesauri or other types of data to establish a concept space, an embodiment in which managers establish a concept space, and an embodiment of establishing a concept space with key words (for example, nouns) appearing in a text document. However, the following description will be made on a basis of manner of using an ontology to establish a concept space.

For using an ontology to establish the concept space 20, available ontologies include various World Knowledge ontologies, for example, Wikipedia, ODP (Open Directory Project), or UMLS (Unified Medical Language System). Although the following description is based on using Wikipedia, the types of available ontologies are not limited to aforementioned examples. In addition, it may be necessary to select and use ontologies, or combine and use two or more ontologies depending on the types of documents included in a document corpus.

In an embodiment of the present invention, an online encyclopedia may be used to establish the concept space 20, for example, the concept space 20 may be established using webpages of online encyclopedias (for example, Wikipedia webpages that are one of online encyclopedias (hereinafter, referred to as Wikipages)).

More specifically, when the concept space is established by using Wikipedia, the Wikipages may be established as a concept constructing the concept space 20, and the corresponding concept may be named after the title of a corresponding Wikipage. For example, if a Wikipage has a URL of http://en.wikipedia.org/wiki/Graphics, the Wikipage itself may be established as one concept, and the corresponding concept may be named after ‘Graphics’, title of the corresponding Wikipage.

However, the aforementioned method of establishing a Wikipage as a concept and naming a corresponding concept after the title of a corresponding Wikipage is just an example, not limiting other methods of establishing and naming a concept.

In this case, the concept space 20 may be reliable as long as the Wikipage established as a concept is in an appropriate level of comprehensiveness and quality. For example, if a Wikipage includes too specific concepts, for example, corresponding to proper nouns, or has poor contents, such a Wikipage should be identified not to be established as a concept.

Therefore, in an embodiment of the present invention, the Wikipage may be selected on the basis of whether the number of Wikipages is below a standard established in advance, the number of the backlinks is below a standard established in advance, or its title includes character entities. However, the aforementioned method does not limit methods of selecting a Wikipage based on other standards.

The above description is about the method of creating a term vector for a specific document dᵢ, and the method of establishing the concept space 20 for concepts of each term included in the term vector created for the specific document dᵢ. Therefore, a method for calculating the weight 50 of each term included in the term vector for a specific document dᵢ for each concept included in the concept space 20 is described hereinbelow.

As described above, the weight 50 of a specific term tⱼ included in a specific document dᵢ for each concept c₁ to c_{c} included in the concept space 20 may be represented as a concept vector. Therefore, the concept vector may be calculated by obtaining the weight 50 of a term for the specific document dᵢ from concept c₁ to concept c_{c} in sequence. However, this is just an example, not limiting an embodiment of concurrently obtaining the weight 50 for the specific document dᵢ for all concepts c₁ to c_{c}. However, the following description is based on the method of obtaining the weight 50 for each concept in sequence.

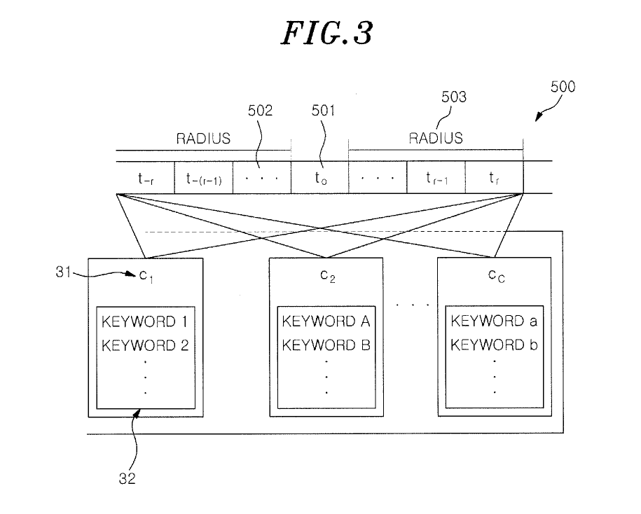

First, referring to FIG. 3, assuming that the term for calculating the weight 50 among the terms included in the term vector is a center term (or a first term) t₀ 501, the weight of the center term t₀ 501 may be calculated on the basis of whether the center term t₀ 501 and the terms t₋ᵣ to tᵣ 502 (hereinafter, referred to as neighboring terms) close to the center term t₀ 501 on the term vector are related to a specific concept c₁31, respectively.

In this case, for example, the center term t₀ 501 may be selected while moving to all terms constructing the term vector in sequence. In addition, for example, the neighboring terms t₋ᵣ to tᵣ 502 may be selected from terms within a distance of radius r 503 before/behind the corresponding center term t₀ 501 on the term vector. In this case, the radius r 503 is a standard for selecting neighboring terms t₋ᵣ to tᵣ 502 based on the center term t₀ 501, and the value of the radius r 503 may be predefined and changed.

If the center term t₀ 501 is a first term or last term, the number of neighboring terms 502 may change. For example, if the center term t₀ 501 is a first term of the term vector, there may be no neighboring terms 502 before the center term.

A CW (concept window) 500 may be established as a concept for selecting a center term t₀ 501 and neighboring terms t₋ᵣ to tᵣ 502 apart from the corresponding center term t₀ 501 as far as the radius r 503. Since the CW 500 for the center term t₀ 501 includes the corresponding center term t₀ 501 and the neighboring terms t₋ᵣ to tᵣ 502 apart before/after the corresponding center term t₀ 501 as far as a distance of radius r 503, the CW 500 may include 2*r+1 terms including the center term t₀ 501. In this case, 2*r+1 may be defined as the size of CW 500. However, such a definition of CW 500 is just an example, not limiting other definitions. In this case, if the center term t₀ 501 is a first term or last term of the term vector, the size of CW 500 is not 2*r+1, and may be the sum of the center term t₀ 501 and the number of neighboring terms 502.

The weight of the center term t₀ 501 of a specific concept based on whether the center term t₀ 501 and the neighboring terms t₋ᵣ to tᵣ 502 are related to a specific concept c₁ 31 may be calculated, for example, by examining whether the center term t₀ 501 and each of the neighboring terms t₋ᵣ to tᵣ 502 are included in the Wikipage of specific concept c₁ 31, and then calculating(setting) the sum of ‘1’ or ‘0’ as a weight in accordance with the definition of inclusion as ‘1’ and otherwise as ‘0’. Further, the sum of ‘1’ or ‘0’ may be divided by 2*r+1 which is a center term and the number of the neighboring terms as a weight.

However, it should be noted that the method for calculating the weight of a center term for a specific concept is just an example, and the present invention does not limit other embodiments including methods for calculating weights in other manners.

In this case, whether the center term t₀ 501 and the neighboring terms t₋ᵣ to tᵣ 502 are included in the Wikipage of a specific concept cₖ 31 may be determined by examining, for example, whether the center term t₀ 501 and each of the neighboring terms t₋ᵣ to tᵣ 502 are included in a specific concept cₖ 31, more specifically, by examining whether they match a keyword 32 (for example, keywords 1 and 2) for the Wikipage of a specific concept cₖ 31. However, this is just an example, and may include other methods, for example, methods for determining matching with entire terms included in the Wikipage of the specific concept cₖ 31, matching with terms included in the Wikipage title of the specific concept cₖ 31, or matching with all terms included in the Wikipage of the specific concept cₖ 31. However, the following description is based on an assumption that determinations are made by examining matching with the keyword 32 included in the Wikipage of the specific concept cₖ 31.

In this case, the keyword 32 included in the Wikipage of the specific concept cₖ may be selected as a term exemplifying characteristics of the corresponding Wikipage. For example, the keyword 32 may be selected by applying the method of tf*idf (Term Frequency*Inverse Document Frequency) to the corresponding Wikipage, which is well known in the art and thus not further described herein. However, the method of tf*idf is just an example, not limiting other methods for selection of a keyword.

The method for obtaining a weight of a specific term tⱼ (center term t₀ 501, in this case) included in a specific document dᵢ for a specific concept c₁ 31 is described hereinabove. Therefore, the concept vector which is a weight 50 of a specific term tⱼ included in a specific document dᵢ for each concept c₁ to c_{c} included in the concept space 20 may be calculated by carrying out the aforementioned method for the remaining concepts c₂ to c_{c} in sequence. However, carrying out the method for the remaining concepts in sequence as described above is just an example.

Meanwhile, if a concept vector for a specific term tⱼ included in a specific document dᵢ is created, the process of calculating a weight for a new specific term may be carried out by moving the center term t₀ 501 (for example, moving from tⱼ to tⱼ₊₁) (accordingly, the CW 500 is also moved) to calculate a concept vector for the new specific term.

Therefore, repetition of the aforementioned process contributes to creating concept vectors for all terms included in a term vector. However, this method is just an example, not limiting other methods for creating concept vectors for all terms included in a term vector.

The aforementioned weight w(cₖ,tⱼ,dᵢ) of a specific term tⱼ included in a specific document dᵢ for a specific concept c₁ 31 may be expressed as the following exemplary Equation 3:

$$w ( {c}_{k} , {t}_{j} , {d}_{i} ) = ‖ {c}_{k} ( \frac{1}{\vert {CW}_{d} ( {t}_{j} ) \vert} * {E}_{{CW}_{d}} ( {t}_{j} ) * C ) ‖ \qquad ( 3 )$$

in which |CW_{d}(tⱼ)| is the size of CW 500; E_{CWd}(tⱼ) is a matrix for showing which term is specified by the CW 500 among the terms included in the term vector of a specific document dᵢ; C is a matrix for showing whether the term included in the term vector of the specific document dᵢ matches the keyword 32 included in each concept of the concept space 20; cₖ( ) means a k-th column vector in the matrix for calculating the contents of the parentheses in cₖ( ); and the symbols ‘∥ ∥’ mean the sum of absolute values of values for all rows in a column vector.

More specifically, E_{CWd}(tⱼ) is a matrix for showing which term is specified by the CW 500 among the terms included in the term vector of the specific document dᵢ, the rows being related to terms specified by the CW 500, and the columns to terms included in the term vector.

In addition, C is a matrix for showing whether the term included in the term vector of the specific document dᵢ matches the keyword 32 included in each concept of the concept space 20, the rows being related to terms included in the term vector, and the columns to the keyword 32 included in each concept.

In addition, since the concept vector cv(tⱼ,dᵢ) 20 of a specific term tⱼ included in a specific document dᵢ is a combination of weights 50 (Equation 3) of the specific term tⱼ for each concept c₁ to c_{c} included in the concept space 20, it may be expressed as the following exemplary Equation 4 with reference to Equation 3:

$$cv ( {t}_{j} , {d}_{i} ) = 〈 ‖ {c}_{1} ( \frac{1}{\vert {CW}_{d} ( {t}_{j} ) \vert} * {E}_{{CW}_{d}} ( {t}_{j} ) * C ) ‖ , … , ‖ {c}_{C} ( \frac{1}{\vert {CW}_{d} ( {t}_{j} ) \vert} * {E}_{{CW}_{d}} ( {t}_{j} ) * C ) ‖ 〉 \qquad ( 4 )$$

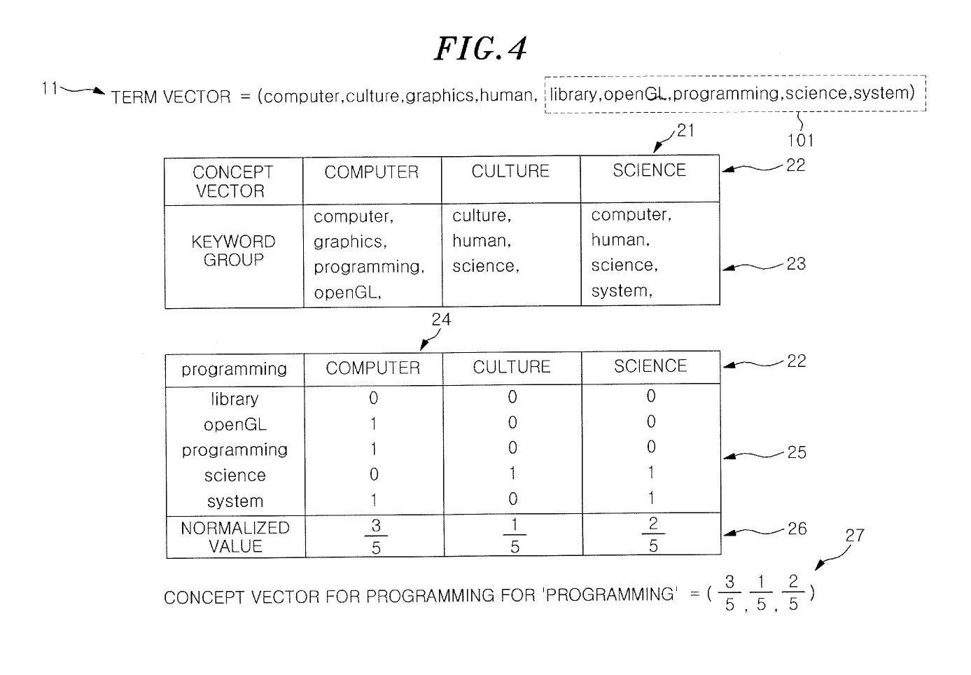

An exemplary method of obtaining the aforementioned concept vector is described hereinafter with reference to FIG. 4. The method used in the example shown in FIG. 4 is for concurrently obtaining the weight for all concepts of a specific term, unlike the method for obtaining the weight for a specific concept of a specific term, and then the weight for the remaining concepts in sequence.

Referring to FIG. 4, in accordance with an embodiment of the present invention, a term vector 11 is created for a corresponding document in order to calculate a concept vector for the terms included in the document. For example, the term vector 11 created for the corresponding document may include 9 terms.

In this case, see the exemplary Table 21 in FIG. 4 for the concept and the keyword included in each concept the concept space includes for the corresponding document.

Referring to FIG. 4, the concept space 22 includes COMPUTER, CULTURE and SCIENCE as concepts, each of which includes keywords 23 of (computer, graphics, programming, system, openGL), (culture, human, science), and (computer, human, science, system).

A method for establishing programming as a center term for which a weight is calculated to calculate a weight for each concept (i.e., COMPUTER, CULTURE, SCIENCE) is described hereinbelow. First, assuming that the radius r is 2, the CW 101 includes 5 terms, and the neighboring terms are ‘library’, ‘openGL’, ‘science’ and ‘system’.

Matching the keywords 23 for each concept space 22 of COMPUTER, CULTURE and SCIENCE with the aforementioned center term and the neighboring terms are indicated as 1 and 0 in 25 of Table 24. For example, as shown in FIG. 4, the keyword, the center term and the neighboring terms, which are included in the concept COMPUTER, match ‘openGL’, programming and system.

After that, the values illustrated in Table 24 are summed for each concept, and the sum is divided by 5 which is the size of the concept window. As shown in Table 24, the values 26 for each concept are 3/5, 1/5 and 2/5, respectively.

Therefore, the concept vector 27 for the center term ‘programming’ is calculated as 3/5, 1/5 and 2/5, as illustrated as a reference numeral 26.

After this process, concept vectors for all terms included in the term vector may be created by repetition of sliding the concept window 101 to move the center term from ‘programming’ to ‘science’ and then carrying out the aforementioned process. Therefore, while representing a corresponding document as a term vector, concept vectors may be represented for all terms included in a term vector, and the corresponding document may thus be represented by using a term-concept matrix.

In this case, if the center term is a first term or last term of a term vector, the number of neighboring terms may change. For example, if the center term is ‘library’ in FIG. 4, there may be two neighboring terms of ‘openGL’ and ‘programming’. In this case, the size of CW may be 3, and the neighboring terms may be ‘programming’ and ‘science’ likewise if the center term is system. In this case, the size of CW may be 3.

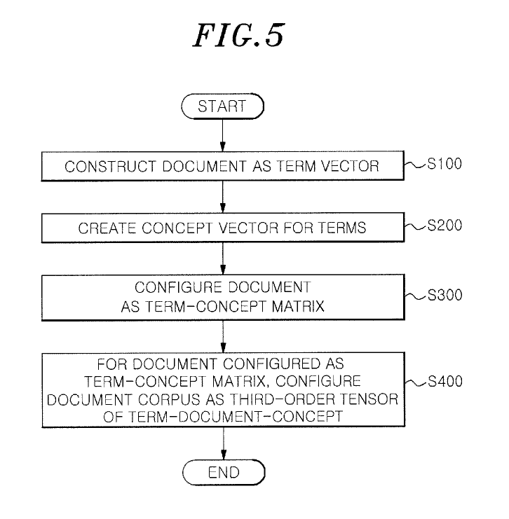

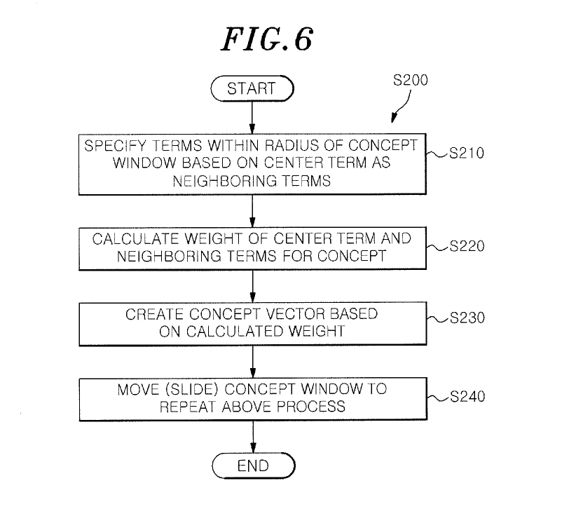

FIGS. 5 and 6 show the method of representing a document as a term-concept matrix, and then representing a document corpus of documents represented as such as a third-order tensor, that is, a cuboid model, of term-document-concept in accordance with an embodiment of the present invention.

Referring to FIGS. 5 and 6 together, a method begins with a process of creating a term vector for a document at operation 5100, and creating a concept vector for each term included in the corresponding term vector at operation 5200.

In this case, the process of creating a concept vector for each term is for establishing a term to create the concept vector as a center term, and specifying terms in a CW specified by a radius r based on the center term established above as neighboring terms at operation S210.

A weight for each concept included in the concept space is subsequently calculated for the center term and the neighboring terms at operation 5220, to create a concept vector based on the weight calculated as such at operation S230.

In this case, the concept space may be established on the basis of an ontology, for example, Wikipedia, and, more specifically, Wikipages of Wikipedia may be established as concepts. In addition, the Wikipages may include keywords exemplifying the corresponding Wikipages.

A weight for a concept may be calculated, for example, by dividing the values based on whether a keyword included in the concept matches a corresponding center term and neighboring terms by the size of CW. In this case, if the keyword included in the concept matches the corresponding center term and the neighboring terms, the weight may be established as ‘1’ and otherwise as ‘0’.

Thereafter, other terms included in the term vector may be established as a center term and the aforementioned process of calculating a weight may be carried out. Concept vectors for all terms included in the term vector may be created by repeating the process of re-establishing other terms included in the term vector as a center term and calculating a weight for all terms included in the term vector at operation S240.

After creating concept vectors for all terms included in the term vector, the corresponding document may be represented by using a term-concept matrix based on the created concept vector at operation 5300. For the resulting document represented by using the term-concept matrix, a document corpus may be represented by using a third-order tensor of term-document-concept at operation 5400.

As described above, with the method of representing a document in accordance with an embodiment of the present invention, it is possible to represent what terms a document includes, and represent what concept a term has in the term space and the concept space for each term.

Some of these operations of the present invention may be realized as computer-readable codes on a computer-readable recording medium. The computer-readable recording medium includes any type of recording device storing data that can be read by a computer system. Examples of the computer readable recording medium include ROM, RAM, CD-ROM, CD-RW, a magnetic tape, a floppy disk, a hard disk driver (HDD), an optical disk, a magneto-optical storage and the like, and also include those that are implemented in the form of carrier waves (such as data transmission through the Internet). The computer-readable recording medium may also store a code that is dispersed in computer systems connected through a network, and read and executed by the computer in a distributed fashion.

The explanation as set forth above is merely described a technical idea of the exemplary embodiments of the present invention, and it will be understood by those skilled in the art to which this invention belongs that various changes and modifications may be made without departing from the scope of the essential characteristics of the embodiments of the present invention. Therefore, the exemplary embodiments disclosed herein are not used to limit the technical idea of the present invention, but to explain the present invention, and the scope of the technical idea of the present invention is not limited to these embodiments. Therefore, the scope of protection of the present invention should be construed as defined in the following claims and changes, modifications and equivalents that fall within the technical idea of the present invention are intended to be embraced by the scope of the claims of the present invention.

What is claimed:

1. A method for representing a document as a matrix in an electronic device comprising a processor and a memory storing instructions executed by the processor, the method comprising:
creating a term vector comprising at least one term in the document;
calculating a weight of each of the at least one term for each of at least one concept occurring in the document; and
representing the document as a matrix by mapping the at least one term included in the document onto any one of rows and columns of the matrix, and mapping the at least one concept onto the other of the rows and columns of the matrix,
wherein the matrix comprises the weight that the at least one term has in the document as a component.

2. The method of claim 1, further comprising creating a concept space comprising the at least one concept.

3. The method of claim 2, wherein the concept space is created by using an ontology.

4. The method of claim 3, wherein the concept is allocated a webpage constructing an online encyclopedia.

5. The method of claim 4, wherein whether to allocate the webpage to the concept is determined on the basis of at least one of the volume of pages of the webpage, the number of backlinks, or special entities included in the title of the webpage.

6. The method of claim 4, wherein the concept comprises at least one keyword calculated by applying tf*idf (Term Frequency*Inverse Document Frequency) to the term contained in the webpage allocated to the concept.

7. The method of claim 1, further comprising creating a concept the weight,
wherein the concept vector is created for each of the at least one term.

8. The method of claim 1, wherein the weight indicates quantitative closeness to each of the at least one concept of each of the at least one term.

9. The method of claim 7, wherein said creating the concept vector for a first term among the at least one term comprises:
establishing the first term as a center term;
establishing terms within a radius predefined in the term vector as neighboring terms based on the first term;
determining whether the first term and each of the neighboring terms are included in each of the at least one concept; and
calculating a weight of the first term for each of the at least one concept on the basis of the result from the determination.

10. The method of claim 9, wherein each of the at least one concept comprises at least one keyword showing a corresponding concept.

11. The method of claim 10, wherein said determining whether the first term and each of the neighboring terms are included in each of the at least one concept is based on determination of whether the first term and each of the neighboring terms match at least one keyword.

12. The method of claim 9, wherein said calculating a weight of the first term for each of the at least one concept comprises:
allocating ‘1’ to the concept of the corresponding term if the first term and each of the neighboring terms are comprised in the concept and otherwise ‘0’; and
calculating the sum of the allocated numbers for each of the at least one concept as a weight of the first term for the concept.

13. The method of claim 12, wherein in said calculating the weight of the first term for each of the at least one concept comprises:
calculating as the weight the value obtained by dividing the sum by the first term and the number of neighboring terms.
